(19) United States
(12) Patent Application Publication
(10) Pub. No.: US 2006/0140708 A1
(43) Pub. Date: Jun. 29, 2006

(54) Liquid cosmetic case

(76) Inventor: Young Kwang Byun, Seoul (KR)

Correspondence Address: BIRCH STEWART KOLASCH & BIRCH, PO BOX 747, FALLS CHURCH, VA, 22040-0747, US

(21) Appl. No.: 11/269,537

(22) Filed: Nov. 9, 2005

(30) Foreign Application Priority Data
Dec. 27, 2004 (KR) 10-2004-0112884
Oct. 10, 2005 (KR) 10-2005-0094842

(51) Int. Cl. A47L 13/22; A46B 17/04; B43M 11/06

(52) U.S. Cl. 401/270; 401/269; 401/186

(57) ABSTRACT

A liquid cosmetic case in which a supporting cap (31) to which a brush is (30) fixed is fixed to the upper side of a tube-shaped container (1) that stores liquid cosmetic and is coupled with a discharger (10) closed after discharging liquid cosmetic and a cap (40) is thread-coupled with the upper side of the tube-shaped container (1) so that the discharger (10) coupled with the supporting cap (31) ascends and descends by opening and closing the cap (40). When the cap (40) ascends, a ring-shaped step (5) in the upper end of a liquid supplying container (6) is opened so that a through hole (12) and a liquid guiding passage (11) formed by an inner protrusion wheel step (7) are connected to a discharge hole (12) and that the liquid cosmetic in the tube-shaped container (1) is discharged to the brush (30). When the cap (40) descends, the ring-shaped step (5) in the upper end of the liquid supplying container (6) is pressed and closed so that the liquid cosmetic stored in the tube-shaped container (1) does not leak and that a user can safely carry the liquid cosmetic case.

### CROSS-REFERENCE TO RELATED APPLICATIONS

This application claims the benefit of Korean Patent Applications No. 10-2004-0112884 and 10-2005-0094842, filed on Dec. 27, 2004 and Oct. 10, 2005, respectively in the Korean Intellectual Property Office, the disclosures of which are incorporated herein by reference.

### BACKGROUND

1. Field of the Invention

The present invention relates to a liquid cosmetic case in which a supporting cap to which a brush is fixed is fixed to the upper side of a tube-shaped container that stores liquid cosmetic and is coupled with a discharger closed after discharging liquid cosmetic and a cap is thread-coupled with the upper side of the tube-shaped container so that the discharger coupled with the supporting cap ascends and descends by opening and closing the cap. When the cap ascends, a ring-shaped step in the upper end of a liquid supplying container is opened so that a through hole and a liquid guiding passage formed by an inner protrusion wheel step are connected to a discharge hole and that the liquid cosmetic in the tube-shaped container is discharged to the brush. When the cap descends, the ring-shaped step in the upper end of the liquid supplying container is pressed and closed so that the liquid cosmetic stored in the tube-shaped container does not leak and that a user can safely carry the liquid cosmetic case.

2. Discussion of Related Art

According to a conventional art, a screw rod with which a piston is thread-coupled to ascend and descend and in which a liquid cosmetic guiding passage is formed so that a ball for opening and closing the liquid cosmetic guiding passage is elastically supported by a spring in the liquid cosmetic guiding passage is provided in a container that stores the liquid cosmetic and is coupled with a body.

Therefore, according to the conventional art, a large number of parts are coupled with each other and the structure is complicated so that manufacturing expenses increase. Also, a user must hold the container and rotate the body several times during use, which is inconvenient.

### SUMMARY OF THE INVENTION

In order to solve the above-described problems, it is an object of the present invention to provide a cosmetic case in which a supporting cap to which a brush is fixed is fixed to the upper side of a tube-shaped container that stores liquid cosmetic and is coupled with a discharger closed after discharging liquid cosmetic and a cap is thread-coupled with the upper side of the tube-shaped container so that the discharger coupled with the supporting cap ascends and descends by opening and closing the cap. When the cap ascends, a ring-shaped step in the upper end of a liquid supplying container is opened so that a through hole and a liquid guiding passage formed by an inner protrusion wheel step are connected to a discharge hole and that the liquid cosmetic in the tube-shaped container is discharged to the brush. When the cap descends, the ring-shaped step in the upper end of the liquid supplying container is pressed and closed so that the liquid cosmetic stored in the tube-shaped container does not leak and that a user can safely carry the cosmetic case. Since the cap is thread-coupled with the upper side of the tube-shaped container, it is possible to prevent the liquid cosmetic from leaking and from being contaminated.

### BRIEF DESCRIPTION OF THE DRAWINGS

These and/or other objects and advantages of the invention will become apparent and more readily appreciated from the following description of preferred embodiments, taken in conjunction with the accompanying drawings of which:

FIG. 1 is a perspective view of a cosmetic case according to the present invention whose cap is opened;

FIG. 2 is an exploded perspective view of the cosmetic case according to the present invention;

FIG. 3 is a sectional view of the cosmetic case according to the present invention;

FIG. 4 is a sectional view illustrating an operation state of the cosmetic case according to the present invention;

FIG. 5 is a sectional view of a cosmetic case according to a first embodiment of the present invention;

FIG. 6 is a sectional view illustrating the operation state of the cosmetic case of FIG. 5;

FIG. 7 is a sectional view of a cosmetic case according to a second embodiment of the present invention;

FIG. 8 is a sectional view of the main part of the operation state of the cosmetic case of FIG. 7;

FIG. 9 is a sectional view of a cosmetic case according to a third embodiment of the present invention; and

FIG. 10 is a sectional view of the main part of the operation state of the cosmetic case of FIG. 9.

### DETAILED DESCRIPTION OF PREFERRED EMBODIMENTS

Hereinafter, preferred embodiments of the present invention will be described with reference to the accompanying drawings.

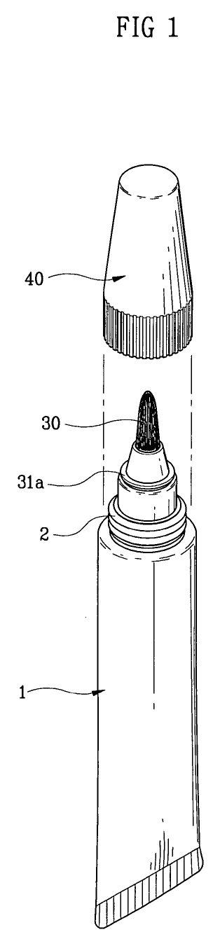

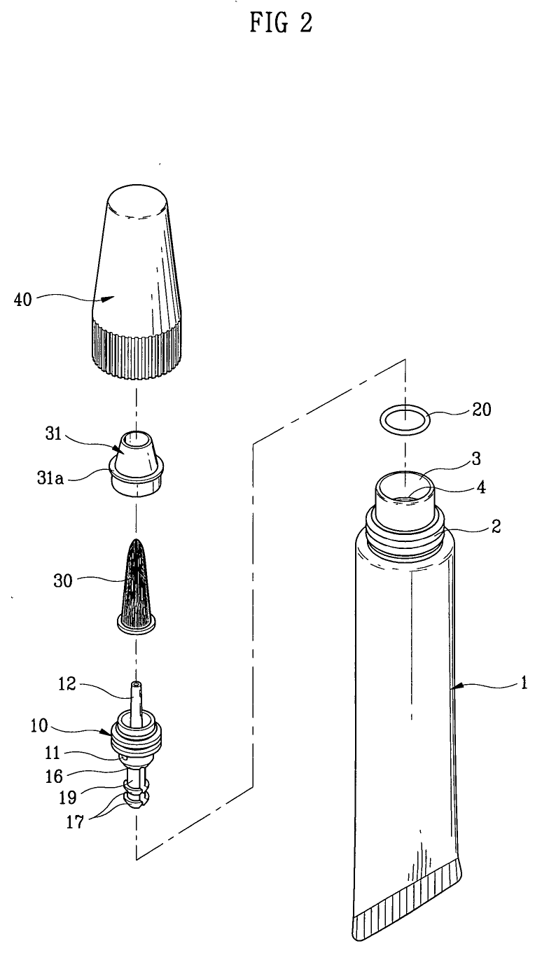

FIGS. 1 to 4 are exploded perspective views of a cosmetic case according to the present invention and sectional views illustrating the coupled state and the operation state of the cosmetic case according to the present invention.

An opening 3 is formed in the upper side of a male thread 2 on the outer circumference wall of a tube-shaped container 1 and a step 4 and a ring-shaped step 5 and an inner protruded wheel step 7 in the lower side of a liquid supplying container 6 are formed on the inner circumference wall of the tube-shaped container 1 so that an additional discharger 10 is inserted to ascend and descend with a sealing O-ring 20 interposed.

A liquid guiding passage 11 horizontally penetrates the discharger 10 in the center of the discharger 10 so that the liquid guiding passage 11 is connected to a discharge hole 12 that vertically penetrates the discharger 10 in the center of the discharger 10. A pressing plate 31a is formed on the circumference of a supporting cap 31 to which a brush 30 is fixed and a groove ring 33 is formed on the inner circumference wall and in the lower end of the discharger 10 so that the groove ring 33 is fixed to the protrusion ring 13 provided on the outer circumference wall and in the upper side of the discharger 10.

A groove 14 into which the sealing O-ring 20 is inserted and a locking step 15 are formed on the outer circumference wall and in the upper side of the discharger 10. A slanted circumference wall 16 whose upper side is wide and whose lower side is narrow is formed in the lower side of the liquid guiding passage 11. Stepped jaws 17 and 17a are formed in the lower end of the slanted circumference wall 16 whose upper side is wide and whose lower side is narrow. Supporters 19 and 19a in which a divided opening 18 that supplies liquid cosmetic is formed are formed in the center of the slanted circumference wall 16.

As described above, the supporting cap 31 to which the brush 30 is fixed is fixed to the protrusion ring 13 of the discharger 10 and the discharger 10 in which the sealing O-ring 20 is inserted into the groove 14 is inserted into the opening 3 of the tube-shaped container 1 so that the sealing O-ring 20 tightly supports the inner circumference wall of the opening 3, that the locking step 15 of the discharger 10 is stopped by the step formed on the inner circumference wall of the opening 3, that the slanted circumference wall 16 whose upper side is wide and whose lower side is narrow of the discharger 10 presses and closes the ring-shaped step 5 of the opening 3, and that the supporters 19 and 19a with the divided opening 18 that are formed in the center of the slanted circumference wall 16 penetrate a through hole 7a formed by the inner protrusion wheel 7 formed in the inner circumference wall and in the lower side of the tube-shaped container 1 to connect the liquid supplying container 6 to the inside of the tube-shaped container 1 through the divided opening 18.

As described above, a cap 40 is thread-coupled with the upper side of the tub-shaped container 1. A female thread 41 corresponding to the male thread 2 formed in the upper side and on the outer circumference wall of the tube-shaped container 1 is formed on the inner circumference wall and in the lower side of the cap 40 and a pressing step 42 and an inner locking wheel 43 are formed on the inner circumference wall and in the center of the cap 40 so that the cap 40 is thread-coupled with the upper side of the tube-shaped container 1. Therefore, the pressing step 42 formed on the inner circumference wall and in the center of the cap 40 is fixed to the upper side of the discharger 10 to press the circumference of the pressing plate 31a formed in the upper side of the outer circumference wall of the supporting cap 31 to which the brush 30 is fixed and to have the discharger 10 descend. Therefore, the slanted circumference wall 16 whose upper side is wide and whose lower side is narrow formed on the outer circumference wall of the discharger 10 presses and closes the ring-shaped step 5 formed on the inner circumference wall and in the upper side of the tube-shaped container 1 to intercept the liquid supplying container 6 connected to the divided opening 18 and the liquid guiding passage 11 connected to a discharge hole 12.

In the above-described state, the pressing plate 31a is pressed by the pressing step formed on the inner circumference wall and in the center of the cap 40 and locked by the inner locking wheel 43. When the cap 40 is rotated to be opened, the pressing plate 31a locked by the inner locking wheel 43 formed on the inner circumference wall and in the center of the cap 40 ascends to a predetermined height together with the cap 40 that ascends while being rotated.

At this time, the discharger 10 coupled with the supporting cap 31 including the pressing plate 31a ascends so that the slanted circumference wall 16 whose upper side is wide and whose lower side is narrow of the discharger 10 deviates from the ring-shaped step 5 of the opening 3 to open the upper side of the liquid supplying container 6. Therefore, the through hole 7a formed by the inner protruded wheel step 7 formed on the inner circumference wall and in the lower end of the tube-shaped container 1 is connected to the liquid guiding passage 11 and the discharge hole 12 so that the liquid cosmetic in the tube-shaped container 1 is discharged to the brush 30.

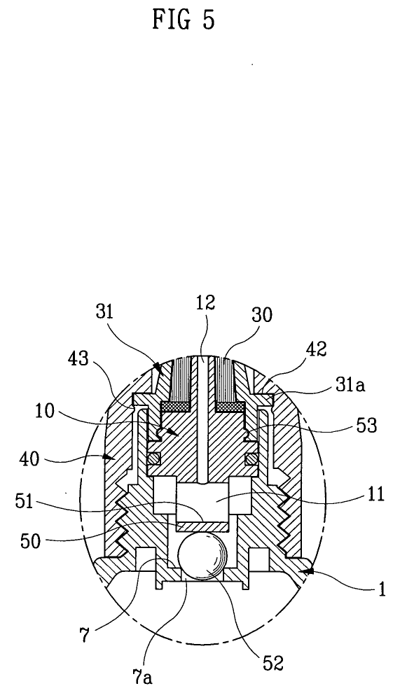

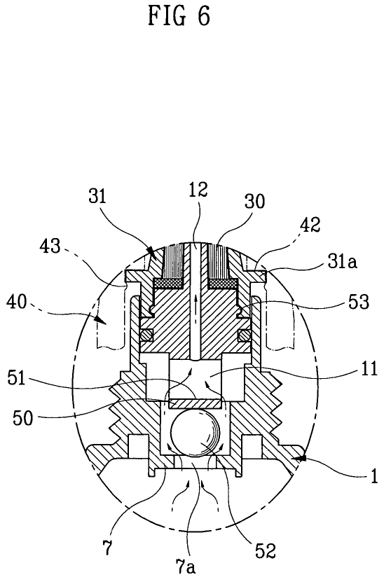

FIGS. 5 and 6 are sectional views illustrating a cosmetic case according to a first embodiment of the present invention. As described in the structure of the discharger 10 of FIGS. 1 to 4, the liquid guiding passage 11 connected to the discharge hole 12 is extended downward to form a supporting plate 50 whose bottom surface is a planar surface 51.

The supporting plate 50 is provided to ascend and descend in the liquid supplying container 6. An opening and closing ball 52 is provided under the supporting plate 50 to open and close the through hole 7a formed by the inner protruded wheel step 7 of the liquid supplying container 6. An outer locking protrusion wheel 53 is provided on the outer circumference wall and in the lower end of the supporting cap 31 to which the brush 30 is fixed and that is fixed to the upper side of the discharger 10. An inner locking protrusion wheel 54 is provided on the inner circumference wall and in the upper end of the tube-shaped container 1 into which the discharger 10 is inserted to ascend and descend. The outer locking protrusion wheel 53 and the inner locking protrusion wheel 54 are coupled with each other so that the discharger 10 does not deviate when the tube-shaped container 1 is pressed.

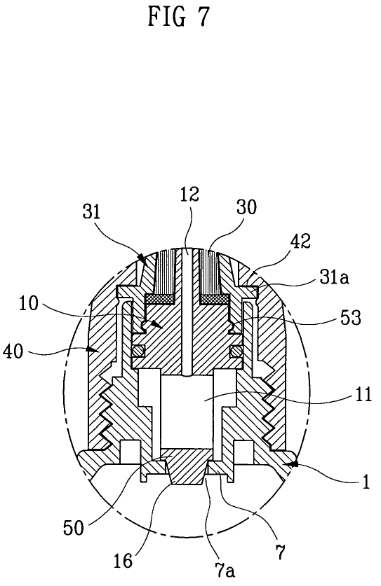

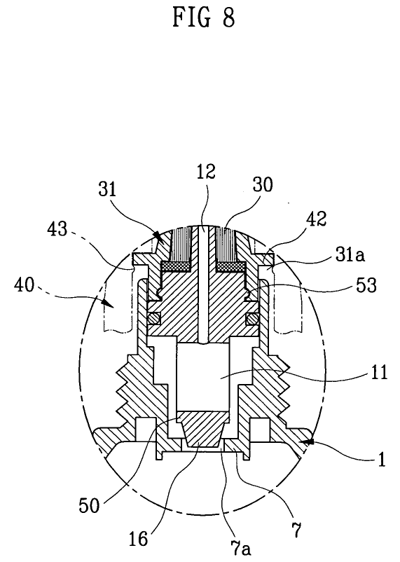

FIGS. 7 and 8 are sectional views illustrating a cosmetic case according to a second embodiment of the present invention. As described with reference to the structure of the discharger 10 of FIGS. 1 to 6, the supporters 19 and 19a formed in the lower side of the slanted circumference wall 16 whose upper side is wide and whose lower side is narrow to form the liquid guiding passage 11 connected to the discharge hole 12 are cut to form the slanted circumference wall 16 whose upper side is wide and whose lower side is narrow on the bottom surface of the supporting plate 50 formed by extending the liquid guiding passage 11 downward. Therefore, the through hole 7a formed by the inner protruded wheel step 7 that forms the liquid supplying container 6 is directly opened and closed.

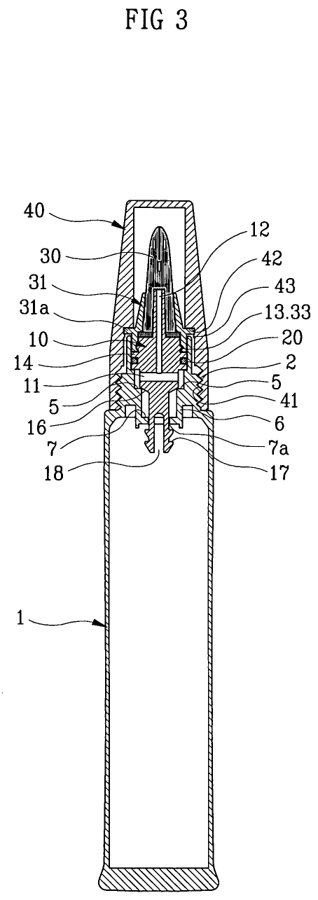

In the state where the cap 40 is thread-coupled with the tube-shaped container 1, as illustrated in FIG. 3, the pressing plate 31a of the supporting cap 31 to which the brush 30 is fixed and that is fixed to the upper side of the discharger 10 is pressed by the pressing step 42 formed on the inner circumference wall and in the upper side of the cap 40 so that the discharger 10 descends and that the slanted circumference wall 16 presses and seals up the ring-shaped step 5 of the tube-shaped container 1. Therefore, it is possible to safely carry the cosmetic case without leaking the liquid cosmetic stored in the tube-shaped container 1 to the outside.

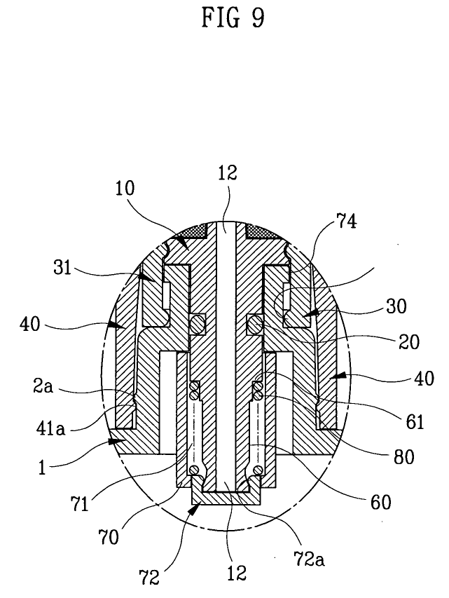

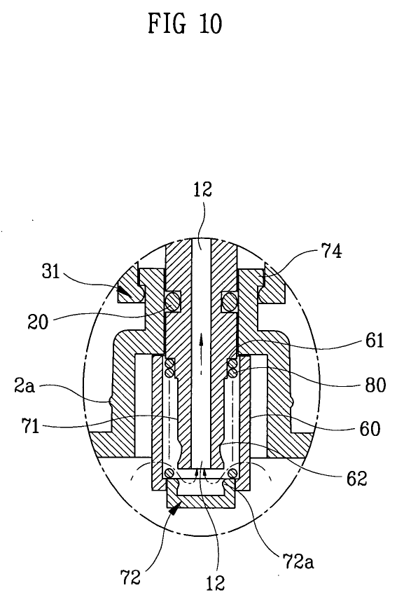

FIGS. 9 and 10 are sectional views illustrating a cosmetic case according to a third embodiment of the present invention. By the male threads 2 of the upper outer circumferential wall of the tube-shaped container 1 of FIGS. 1 to 8, an outer protruded ring 2a of the tube-shaped container 1, and an inner protruded ring 41a of the cap 40, the cap 40 on the top of the tub-shaped container 1 can be forcibly opened without female treads 41 formed in the lower inner circumferential wall of the cap 40. Moreover, without the liquid guiding passage 11 formed in the center of the discharge hole 12, a vertical body 60, in which the discharge hole 12 is vertically extended, is formed. In corresponding to the structure of an upper step 61 formed in the upper side of the vertical body 60 and a groove ring 62 formed in the lower side of the outer circumferential wall of the vertical body 60, several erected pieces 70 formed in the upper inner circumferential wall of the tube-shaped container 1 to open the circumference of the liquid supplying container 6 such that a liquid supplying part 71 is formed. A through-hole 7a formed in the lower end is closed such that an opening and closing cap 72, in which an inner protruded ring 72a is formed in corresponding to the groove ring 62 of the vertical body 60, is formed in the upper side of the inner circumferential wall to open and to close the discharge hole 12 formed in the vertical body 60. An elastic spring 80 is disposed between the upper step 61 of the vertical body 60 and the opening and closing cap 72 such that the opening and closing cap 72 is safely operated by the erected pieces 70 for defining the liquid supplying part 71. An inner locking protruded wheel 73 is formed in the inner lower circumferential wall of the supporting cap 31 in which the brush 30 is fixed to and is engaged with the upper side of the discharger 10 to cover the supporting cap 31. An outer locking protruded wheel 74 is formed in the upper side of the outer circumferential wall of the tube-shaped container 1 and is engaged with the inner locking protruded wheel 73 such that the discharger 10 is not separated when pressing the tube-shaped container 1.

In the liquid cosmetic case according to the preferred embodiment of the present invention as described above, the state of the cap 40 being thread-coupled with the tube-shaped container 1, as shown in FIG. 1, is the state in which the pressing plate 31a of the supporting cap 31 in which the brush 30 is fixed to and covers the upper side of the discharger 10 is pressed by the pressing step 42 formed in the upper side of the inner circumferential wall of the cap 40 such that the slanted circumference wall 16 presses and closes the ring-shaped step 5 of the tube-shaped container 1. Thus, the liquid cosmetic stored in the tube-shaped container 1 does not leak and is safely stored.

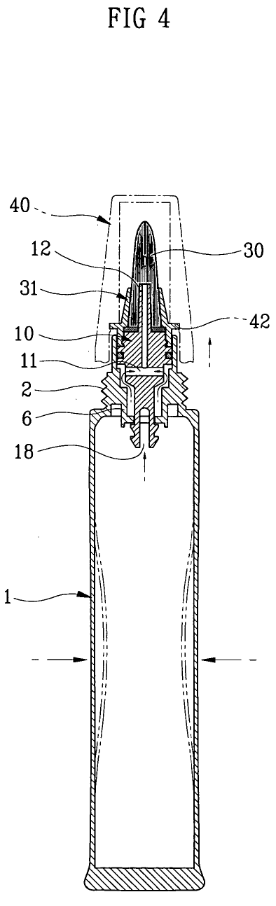

When using the liquid cosmetic case according to the preferred embodiment of the present invention, as shown in FIG. 4, the cap 40 thread-coupled with the upper side of the tube-shaped container 1 is turned to open the tube-shaped container 1. At that time, as the pressing plate 31a, locked to the inner locking wheel 43 formed in the center of the inner circumferential wall of the cap 40, is rotated to ascend to a predetermined height together the ascending cap 40, the discharger 10 coupled with the supporting cap 31 in which the pressing plate 31a is formed ascends together them so that the slanted circumference wall 16 with a wide upper side and a narrow lower side of the discharger 10 is separated from the ring-shaped step 5 of the opening 3 and the upper side of the liquid supplying container 6 is opened. The divided opening 18 of the discharger 10, the liquid supplying container 6, the liquid guiding passage 11, and the discharge hole 12 are communicated with each other such that the tube-shaped container 1 is held by hand and is pressed so that the liquid cosmetic stored in the tube-shaped container 1 is discharged and is impregnated into the brush 30.

When the discharger 10 ascends due to the pressing the tube-shaped container 1, the stepped jaws 17 and 17a formed in the lower sides of the divided opening 18 are obstructed by the inner protruded wheel step 7 forming the through hole 7a so that the discharger 10 does not excessively ascend.

Moreover, as shown in FIGS. 5 and 6 illustrating the first preferred embodiment of the present invention, in the state of opening the through-hole 7a due to the pressure generated by opening the cap 40 thread-coupled with the tube-shaped container 1 and pressing the tube-shaped container 1, the opening and closing ball 52 ascends and the tube-shaped container 1 is communicated with the liquid supplying container 6, the liquid guiding passage 11, and the discharge hole 12 through the through-hole 7a such that the liquid cosmetic stored in the tube-shaped container 1 is discharged through the discharge hole 12 and is impregnated into the brush 30.

By repeating the above actions, the liquid cosmetic stored in the tube-shaped container 1. At that time, the outer locking protrusion wheel 53 of the supporting cap 31 fixed to the upper side of the discharge 10 is locked to the inner locking protrusion wheel 54 formed in the upper side of the inner circumference wall of the opening 3 so that ring the discharger 10 is not separated and is safely used.

As shown in FIGS. 7 and 8 illustrating the second preferred embodiment of the present invention, the discharger 10 ascends, as shown in FIG. 7, due to the pressure generated in the tube-shaped container 1 by opening the cap 40 thread-coupled with the tube-shaped container 1 and pressing the tube-shaped container 1, and the slanted circumference wall 16 for closing the through-hole 7a formed by the inner protruded wheel step 7 ascends such that the through-hole 7a, the liquid guiding passage 11, and the discharge hole 12 are communicated with each other so that the liquid cosmetic stored in the tube-shaped container 1 is discharged through the discharge hole 12 and is impregnated into the brush 30.

After use, the cap 40 is thread-coupled with the upper side of the tube-shaped container 1 such that the slanted circumference wall 16 securely closes the through-hole 7a so that the liquid cosmetic stored in the tube-shaped container 1 is prevented from leaking.

As shown in FIGS. 9 and 10 illustrating the third preferred embodiment of the present invention, when opening the cap 40 thread-coupled with the tube-shaped container 1, the pressing step 42 formed in the central portion of the inner circumference wall of the cap 40 releases the pressing plate 31a engaged with the upper side of the discharger 10 and is elastically supported by the upper step 61 of the vertical body 60 of the discharger 10 and the upper side of the opening and closing cap 72 such that the discharger 10 ascends due to the elastic force of the elastic spring 60 installed between the circumference of the vertical body 60 and the erected pieces 70. At that time, the lower side of the discharge hole 12 pressing and closing the lower side of the vertical body 60 is opened such that the tube-shaped container 1 is communicated with the discharge hole 12 by communicating the several erected pieces 70 with the discharge hole 12.

Thus, due to the pressure generated by pressing the tube-shaped container 1, the liquid cosmetic stored in the tube-shaped container 1 is discharged and impregnated into the brush 30.

As such, after using the brush 30 into which the liquid cosmetic is impregnated, the cap 40 is thread-coupled with the upper side of the tube-shaped container 1 again such that the pressing step 42 of the cap 40 presses the pressing plate 31a of the supporting cap 31 engaged with the upper side of the discharger 10 and the lower side of the vertical body 60 contacts the inner bottom of the opening and closing cap 72 so that the inner protruded ring 72a in the inner circumference wall of the opening and closing cap 72 is engaged with the groove ring 62 formed in the outer circumference wall of the vertical body 60. Thus, the tube-shaped container 1 and the discharge hole 12 are securely pressed and closed.

At that time, since the elastic spring 80 is elastically pressed between the upper step 61 of the vertical body 60 and the upper circumference of the opening and closing cap 72, the liquid cosmetic stored in the tube-shaped container 1 does not leak and is safely stored.

Therefore, the liquid cosmetic case according to the preferred embodiments of the present invention is structured such that the discharger 10 coupled with the supporting cap 31 automatically ascends and descends due to the opening and closing of the cap 40. When the cap 40 ascends, the ring-shaped step 5 as the upper side of the liquid supplying container 6 is opened such that the through-hole 7a formed in the form of the inner protruded wheel step 7, the liquid guiding passage 11, and the discharge hole 12 are communicated with each other so that the liquid cosmetic in the tube-shaped container 1 is discharged to the brush 30. When the cap 40 descends, since the ring-shaped step 5 as the upper side of the liquid supplying container 6 is pressed and closed, the liquid cosmetic stored in the tube-shaped container 1 does not leak and is safely stored.

As described above, the supporting cap, in which the brush is fixed, is fixed to the upper side of the tube-shaped container for storing the liquid cosmetic and the discharger for discharging the liquid cosmetic is coupled with the upper side of the tube-shaped container such that the cap is thread-coupled with the tube-shaped container so that the discharger coupled with the supporting cap automatically ascends and descends due to the opening and closing of the cap. Thus, when the cap ascends, the ring-shaped step as the upper side of the liquid supplying container is opened such that the through-hole formed by the inner protruded wheel step, the liquid guiding passage, and the discharge hole are communicated with each other so that the liquid cosmetic in the tube-shaped container is discharged to the brush. When the cap descends, since the ring-shaped step as the upper side of the liquid supplying container is pressed and closed, the liquid cosmetic stored in the tube-shaped container does not leak and is safely stored. When using the liquid cosmetic case, since a desired amount of the liquid cosmetic is easily discharged by repeatedly pressing the tube-shaped container as a user's wish, loss of the liquid cosmetic can be prevented.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A liquid cosmetic case comprising a tube-shaped container (1) in which an opening (3) discharging a liquid cosmetic and having a male thread (2) formed in the upper side of an outer circumference wall and a brush (30) are installed, and a cap (40) having a female thread (41) formed in the lower side of an inner circumference wall thereof and thread-coupled with the male thread (2), the liquid cosmetic case comprising:
a discharger (10) comprising:
a step (4) and a ring-shaped step (5) formed in the upper side of the inner circumference wall of the opening (3) formed in the upper side of the tube-shaped container (1);
a liquid supplying container (6);
an inner protruded wheel step (7);
a supporting cap (31) engaged with the upper side of the inner circumference wall of the discharger (10) and having a through-hole (7a) to surround the brush (30);
a liquid guiding passage (11) formed in the lower side of the outer circumference wall in which a groove 14 and locking step (15) are formed such that the liquid guiding passage (11) is communicated with the discharge hole (12) in the horizontal direction by penetrating the outer circumference wall;
a slanted circumference wall (16) having a wide upper side and a narrow lower side;
a divided opening (18); and
stepped jaws (17 and 17a) formed in supports (19 and 19a) formed by the liquid guiding passage (11), the slanted circumference wall (16), and the divided opening (18), wherein the discharger (10) is coupled with the tube-shaped container (10) by a sealing O-ring (20); and
a cap (40) including a pressing step (42) formed in the center of the inner circumference wall thereof and thread-coupled with the tube-shaped container (10).

2. The liquid cosmetic case as claimed in claim 1, wherein the discharger (10) further comprises a supporting plate (31a) formed in the circumference of the supporting cap (31) engaged with the upper side of the discharger (10) to correspond the pressing step (42) of the cap (40).

3. The liquid cosmetic case as claimed in claim 1, wherein the liquid guiding passage (11), the slanted circumference wall (16) and the divided opening (18) for forming the discharger (10) extend the liquid guiding passage (11) directly downward such that an opening and closing ball (42) is disposed in the lower side of a supporting plate (50) formed by extending the liquid guiding passage (11) directly downward.

4. The liquid cosmetic case as claimed in claim 1, wherein the slanted circumference wall (16) is formed in the lower side of the supporting plate (50) formed by extending the liquid guiding passage (11) of the discharger (10) directly downward.

5. A liquid cosmetic case comprising:
a structure in which an opening and closing cap (72) is formed and has structure in which a tube-shaped container (1) and a cap (40) are coupled with each other by a structure in which an outer protruded wheel (2a) and an outer locking protruded wheel (74) formed in the upper side of the outer circumference wall of an opening formed in the upper side of the tube-shaped container (1) and a structure in which an inner protruded wheel (41a) formed in the lower side of the inner circumference wall of the cap (40), plural erected pieces (70) are installed in the opening formed in the upper side of the tube-shaped container (1) to form a liquid supplying part (71), and an inner protruded ring (72a) is formed in the lower side of the erected pieces (70);
a structure in which an inner locking protruded wheel (73) is formed in the lower side of the supporting cap (31) engaged with the upper side of the discharger (10) by fixing a brush (30); and
an elastic spring (80) disposed between the opening cap (72) and an upper step (61) such that the discharger (10), in which a vertical body (60) having the upper step (61) formed in the lower side of the discharger (10), is coupled between the opening cap (72) and the upper step (61).
